(19) United States
(12) Patent Application Publication
(10) Pub. No.: US 2026/0018640 A1
(43) Pub. Date: Jan. 15, 2026

(54) Selectively Annealed Electrochemical Catalyst

(71) Applicant: Robert Bosch Gmbh, Stuttgart (DE)

(72) Inventors: Daniil A. KITCHAEV, Brookline, MA (US); Matthias HANAUER, Leonberg (DE); Ulrich BERNER, Stuttgart (DE); Ulrich SAUTER, Karlsruhe (DE)

(21) Appl. No.: 18/769,497

(22) Filed: Jul. 11, 2024

(51) Int. Cl. H01M 8/1004; H01M 4/86; H01M 4/92; H01M 8/18

(52) U.S. Cl. CPC H01M 8/1004; H01M 4/8657; H01M 4/925; H01M 8/18

(57) ABSTRACT

An electrochemical cell includes a membrane electrode assembly having an electrode catalyst material including a plurality of catalyst nanoparticles at least some of which include a magnetic material and an AC magnet generating oscillating magnetic field adjacent the catalyst material, the oscillating magnetic field having a frequency of up to 500 KHz.

### TECHNICAL FIELD

The present disclosure relates to an electrochemical cell including a catalyst having magnetic particles, an oscillating magnetic field, or both, and methods of utilizing the oscillating magnetic field for catalyst performance enhancement.

### BACKGROUND

With an ever-increasing growing interest in green technologies worldwide, electrochemical cells such as fuel cells and electrolyzers are top candidates for various applications. Yet many challenges need to be resolved prior to wide-spread electrochemical cell implementation. Among the challenges is aging of the electrocatalyst which presented a costly component prone to degradation.

### SUMMARY

In one embodiment, an electrochemical cell is disclosed. The cell includes a membrane electrode assembly having an electrode catalyst material including a plurality of catalyst nanoparticles at least some of which include a magnetic material. The assembly further includes an AC magnet generating oscillating magnetic field adjacent the catalyst material, the oscillating magnetic field having a frequency of up to 500 kHz. The plurality of catalyst nanoparticles may include core-shell particles, each of which have a shell consisting of at least one precious metal and a core including the magnetic material. The plurality of catalyst nanoparticles may include particles having a core including a mixture of at least one precious metal and a non-precious metal magnetic material. The plurality of catalyst nanoparticles may include particles having a core including the magnetic material, a shell consisting of a precious metal material, and an intermediate layer between the core and the shell, the intermediate layer comprising a combination of a non-precious magnetic metal and a precious metal. The magnetic material may be a superparamagnetic material. The oscillating magnetic field may have a magnitude of up to about 100 mT. The cell may be a fuel cell. The cell may be an electrolyzer. The AC magnet may be an integral part of the cell.

In another embodiment, a system for catalyst regeneration in an electrochemical cell is disclosed. The system may include a membrane electrode assembly including an electrode catalyst material having a plurality of catalyst nanoparticles comprising a magnetic material. The system may further include a removable AC magnet generating oscillating magnetic field having a frequency of up to 500 kHz. The system may further include a controller programmed to activate the oscillating magnetic field at a predetermined interval after the cell operation. The plurality of catalyst nanoparticles may include core-shell particles having a shell including a precious metal and a core including the magnetic material. The system may also include one or more sensors located on the electrode catalyst material, the sensors collecting input to be provided to the controller. The plurality of catalyst nanoparticles may include particles having a core including the magnetic material, a shell consisting of a precious metal material, and an intermediate layer between the core and the shell, the intermediate layer comprising a combination of a non-precious magnetic metal and a precious metal. The oscillating magnetic field may have a magnitude of up to about 100 mT. The magnetic material may include Pt—Co, Pt—Ni, Pt—Fe, Ir—Co, Ir—Ni, Ir—Fe, Rh—Co, Rh—Ni, Rh—Fe, their oxides, or their combination. The cell may be a fuel cell. The cell may be an electrolyzer.

In yet another embodiment, a method of catalyst regeneration in an electrochemical cell is disclosed. The method may include providing an AC magnet adjacent a magnetic catalyst in the cell. The method may also include activating the AC magnet to generate an oscillating magnetic field. The method may also include selectively increasing temperature of the magnetic catalyst in the cell by the magnetic heat generated by the oscillating magnetic field while maintaining temperature of non-magnetic components of the cell. The method may likewise include applying the magnetic heat for a period of time sufficient to increase crystallinity and structural stability of the catalyst. The activating may be done periodically. The activating may be based on input from one or more sensors collecting data from the catalyst. The activating may be provided in reducing conditions to aid in removal of oxygen damage of the catalyst. The AC magnet may be provided as an integral part of the cell. The method may also include applying the oscillating magnetic field at a frequency of up to 500 kHz. The cell may be a fuel cell. The cell may be an electrolyzer.

### BRIEF DESCRIPTION OF THE DRAWINGS

FIG. 1A shows a non-limiting example of a fuel cell and its components in an exploded view;

FIG. 1B shows a schematic depiction of a membrane electrode assembly (MEA) and its functioning principle;

FIG. 2A shows a schematic view of a non-limiting example of an electrolyzer stack;

FIG. 2B is a schematic depiction of the electrolysis principle;

FIGS. 3A and 3B illustrate schematically conventional process for catalyst particle skin formation on a Pt-M alloy surface, the images are from Watanabe, M., Yano, H., Tryk, D. A., & Uchida, H. (2016), Highly durable and active PtCo alloy/graphitized carbon black cathode catalysts by controlled deposition of stabilized Pt skin layers. Journal of The Electrochemical Society, 163 (6), F455;

FIGS. 4A and 4B show schematic depictions of core-shell catalyst magnetic particles;

FIG. 4C shows a single phase magnetic catalyst particle;

FIG. 5 shows a schematic depiction of the oscillating magnetic field heating of a magnetic catalyst particle according to one or more embodiments disclosed herein;

FIGS. 6A and 6B are non-limiting schematic examples of an electrochemical cell including the magnetic catalyst and an AC magnet according to embodiments disclosed herein;

FIG. 7 depicts chemical composition of a PtCo catalyst nanoparticle in the bulk of the particle and its surface at thermodynamic equilibrium; and

FIG. 8 depicts measured magnetization of a fuel cell electrode containing magnetic PtCo nanoparticle catalysts.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: percent, “parts of,” and ratio values are by weight; the description of a group or class of materials as suitable or preferred for a given purpose in connection with the disclosure implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed. Unless stated otherwise, the wt. % is based on the total weight of the substrate and the vol. % is based on the total volume of the substrate.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the disclosure can be obtained within a range of +/−5% of the indicated value. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . , 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. Similarly, whenever listing integers are provided herein, it should also be appreciated that the listing of integers explicitly includes ranges of any two integers within the listing.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

As used herein, the term “and/or” means that either all or only one of the elements of said group may be present. For example, “A and/or B” means “only A, or only B, or both A and B”. In the case of “only A,” the term also covers the possibility that B is absent, i.e. “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The term “comprising” is synonymous with “including,” “having,” “containing,” or “characterized by.” These terms are inclusive and open-ended and do not exclude additional, unrecited elements or method steps. The term “including” or “includes” may encompass the phrases “comprise,” “consist of,” or “essentially consist of.”

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Also, the description of a group or class of materials as suitable for a given purpose in connection with one or more embodiments implies that the group or class of materials can “comprise,” “consist of,” and/or “consist essentially of” any member or the entirety of that group or class of materials. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Chemical and electrochemical systems utilizing hydrogen as a fuel source are considered the energy systems of the future either in direct hydrogen combustion engines or fuel cells. These hydrogen-based devices are becoming increasingly popular due to their ability to produce clean energy. The systems may include fuel cells, or relatedly, electrolysis cells or electrolyzers used in the production of hydrogen. Fuel cells, or electrochemical cells, that convert chemical energy of a fuel (e.g. H₂) and an oxidizing agent into electricity through a pair of electrochemical half (redox) reactions, have become an increasingly popular hydrogen-fuel-conversion technology. Fuel cells are now a key technological component of a promising alternative energy storage, transportation and conversion ecosystem capable of operating without emissions of either toxins or green-house gases.

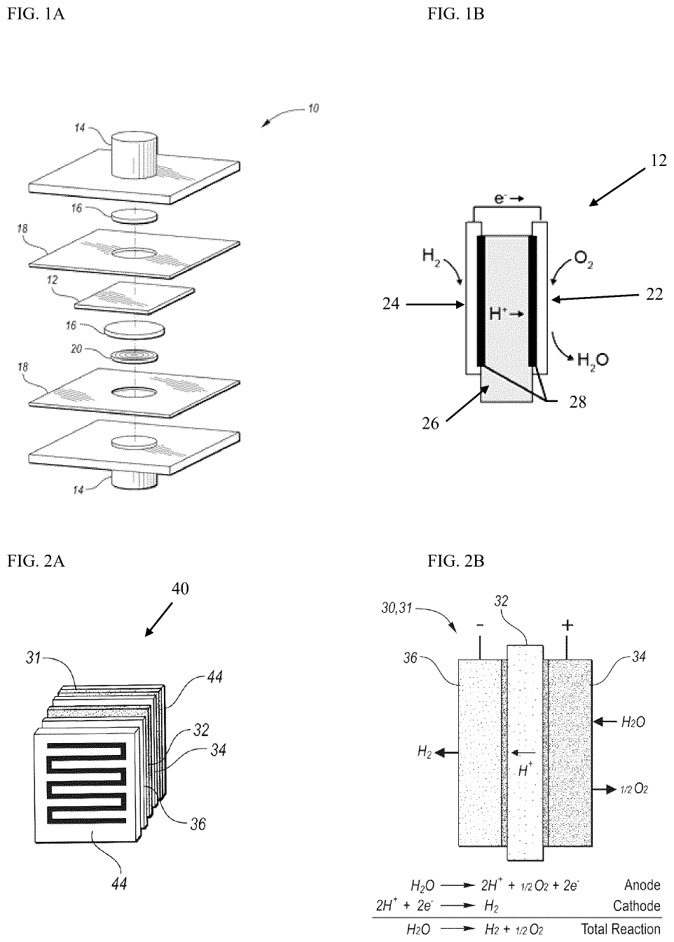

A non-limiting example of a fuel cell, a proton-exchange membrane fuel cell (PEMFC) is depicted in FIG. 1A. A core component of the PEMFC 10 that helps produce the electrochemical reactions needed to separate electrons and ions is the Membrane Electrode Assembly (MEA) 12. The MEA 12 includes subcomponents such as the catalyst-coated cathode 22 and anode 24 electrodes separated by a proton-conductive ionomer or ionomer membrane 26; a catalyst is denoted as 28 in a schematic depiction of MEA in FIG. 1B. Besides MEA 12, the PEMFC 10 typically includes other components such as current collectors 14, gas diffusion layer(s) (GDL) 16, gaskets 18, and bipolar plate(s) 20.

In a PEMFC, the anode performs the hydrogen oxidation reaction (1) while the cathode performs the oxygen reduction reaction (2):

H₂->2H⁺+2e^{-s} (1)

4H⁺+O₂+4e⁻->H₂O (2)

Generally, the H₂ is broken down on the surface of the electrocatalyst in the anode to form protons and electrons in a hydrogen oxidation reaction (HOR). The electrons are transported through the support of the anode catalyst layer to the external circuit while the protons are pulled through the proton exchange membrane (PEM) to the cathode catalyst layer. Once in the cathode catalyst layer, the protons move through the ion-conducting polymer or ionomer thin-film network to the electrocatalyst surface, where they combine with the electrons from the external circuit and the O₂ that has diffused through the pores of the cathode catalyst layer (CCL) to form water in the oxygen reduction reaction (ORR).

Besides fuel cells, electrolyzers present another type of an electrochemical cell. Electrolyzers use electrical energy to conduct chemical reactions. Electrolyzers undergo an electrolysis process to split water into hydrogen and oxygen, providing a promising method for hydrogen generation from renewable resources. An electrolyzer, like a fuel cell, includes an anode and cathode catalyst layers separated by an electrolyte membrane. The electrolyte membrane may be a polymer, an alkaline solution, or a solid ceramic material. A catalyst material is included in the anode and cathode catalyst layers of the electrolyzer.

Besides fuel cells, the electrolyzer may be utilized in other applications including industrial, residential, and military applications and technologies focused on energy storage such as electrical grid stabilization from dynamic electrical sources including wind turbines, solar cells, or localized hydrogen production.

A typical single electrolyzer is composed of an electrolyte membrane, an anode layer, and a cathode layer separated from the anode layer by the electrolyte membrane. A non-limiting schematic depiction of an electrolyzer stack 40 is shown in FIG. 2A. The electrolyzer stack 40 includes individual electrolyzer cells 31, each of which includes the membrane 32, electrodes 34, 36, and bipolar plates 44. A catalyst material, such as Ir- or Pt-based catalysts, is included in the anode and cathode layers 34, 36 of the electrolyzer stack 40. At the anode layers 34, H₂O is hydrolyzed to O₂ and H⁺ (2H₂O→O₂+4H⁺+4e⁻). At the cathode layers 36, H⁺ combines with electrons to form H₂ (4H⁺+4e⁻→2H₂).

A depiction of the electrolysis principle, utilized by a proton exchange membrane (PEM) electrolyzer 30, with relevant reactions is depicted in FIG. 2B. The electrolyzer 30 includes the PEM 32, anode 34, and cathode 36. Each electrode includes a porous transport layer (PTL) and a catalyst layer. During electrolysis, water is broken down into oxygen and hydrogen in anodic and cathodic electrically driven evolution reactions. The reactant liquid water (H₂O) permeates through the anode 34 PTL to the anode catalyst layer, where the oxygen evolution reaction (OER) occurs. The protons (H⁺) travel via the PEM 32, and electrons (e⁻) conduct through an external circuit during the hydrogen evolution reaction (HER) at the cathode 36 catalyst layer. The anodic OER requires a much higher overpotential than the cathodic HER. It is the anodic OER which determines efficiency of the water splitting due to the sluggish nature of its four-electron transfer.

The performance of electrochemical systems is limited by the rate of critical reactions which are catalyzed at the electrodes. In PEMFC systems, the rate limiting step is the oxygen reduction reaction (ORR) which takes place at the cathode or the reaction (2) discussed above.

To compensate for the sluggish kinetics, the electrode is loaded with a quantity of precious-metal catalyst to catalyze the rate limiting reactions. Yet, the catalysts typically increase the overall cost of the device and are prone to degradation. The catalysts may include various materials, but typically include one or more precious metals and alloys, or their oxides, such as Pt, Pt—Co, Pt—Ni, Pt—Fe, Ir, Ir—Ti, Rh, PtOₓ, IrOₓ, the like, or their combination.

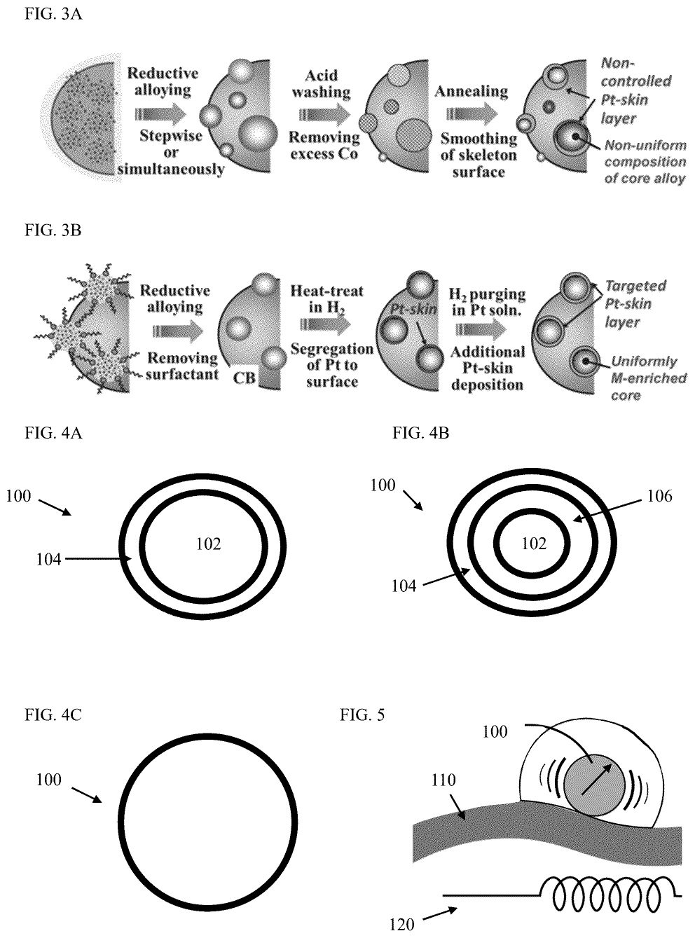

In recent years, alloy particles with a core-shell structure (e.g. PtₓCo core and Pt shell) have turned out to offer relatively high catalytic activity at a relatively low precious metal content. A catalyst having a core-shell structure forms a surface of pure precious metal such as Pt while the core is a mixture of precious and non-precious metals such as Co and Pt. While a thin shell having a few atomic layers is advantageous for catalytic activity, its fragility may be problematic because insufficient robustness may result in local defects, leaching of precious and/or non-precious components, which may result in undesirable catalyst degradation. For example, if Co leaches out of the core and comes into the electrochemical cell environment, is succumbs to dissolution. To ensure that the shell is closed and possesses a high degree of crystallinity to ensure high stability, thermal annealing steps are typically used in established synthesis routes. FIG. 3 shows two state-of-the-art thermal annealing procedures.

FIG. 3A shows a conventional process for Pt-skin formation on a Pt-M alloy surface, starting from alloys with excess M content, non-uniform size distribution, and composition. The synthesis route of FIG. 3A removes some of the non-precious metal component through acid washing, and the core-shell structure is then further developed and stabilized through a thermal annealing step.

FIG. 3B shows a process for Pt-skin formation, starting from an alloy with a discrete M content, uniform size distribution, and composition, where the compositions are appropriate for the formation of particles including nearly pure non-precious metal M cores and one Pt-skin layer. In the process of FIG. 3B, a reductive thermal annealing step is followed by chemical deposition of further layers of the precious metal shell in a solution containing precious metal ions.

Yet, the typical processes of core shell formation have drawbacks. Overall, the thermal annealing leads to undesirable particle coarsening. If the precious metal nanoparticles are heated up, they tend to agglomerate. The agglomeration results in increased size and the nanoparticles may no longer present a nanoparticle system. Thus, while annealing provides heat, the heat may cause unwanted agglomeration of the precious metal particles.

Additionally, thermal annealing cannot be used once the catalyst is integrated into the electrochemical cell. During operation of the cell, the surface protective layer of the precious metal such as Pt degrades over time as the shell loses its crystallinity, and some of the non-precious metal such as Co dissolves away. The core shell structure cannot be strengthened to increase its crystallinity by heat generated by homogeneous thermal annealing of the full system at that point as the polymeric materials of the electrochemical cell environment would melt or otherwise be damaged.

Hence, there is a need to improve robustness of the core shell catalyst particles during synthesis and during the catalyst's lifetime.

In one or more embodiments, an electrochemical cell is disclosed. The cell may be a fuel cell or an electrolyzer. The cell may include one or more components typical for a cell such as those described herein.

As such, the cell may include one or more MEA, electrodes, an anode, a cathode, a membrane, current collectors, GDL, gaskets, bipolar plates, and other components.

The cell may include one or more catalysts or electrocatalysts. The catalysts may be present on the cathode, anode, or both. The catalyst may include one or more particles such as nanoparticles. The nanoparticles may be free of agglomerations. The nanoparticles may be single phase or include a core and a shell or skin such that the particles include a core-shell structure. The shell may include a relatively thin layer, or a plurality of atomic layers, of a precious metal or metal oxide such as Pt, Ir, Rh, PtOₓ, IrOₓ or their combination. The shell may include pure precious metal(s) or their oxide(s). The core may include a combination, blend, or mixture of materials. The materials may include a precious metal and a non-precious metal. The non-precious metal may include a magnetic, ferro-magnetic, or superparamagnetic material, including, but not limited to, Co, Ni, Fe, or their alloy(s). The mixture may be homogenous or heterogeneous. The catalyst may be a magnetic catalyst. The catalyst may be a nanocatalyst or a catalyst including a plurality of nanoparticles or particles on the nano scale.

As such, the catalyst includes a magnetic material such as ferromagnetic material, superparamagnetic material, or a combination thereof. The magnetic material may form part of the core-shell geometry. The catalyst may be deposited in a core-shell geometry on a magnetic material. In non-limiting examples, the catalyst may be a ferromagnetic Pt—Co, Pt—Fe, Pt—Nd, Ir—Co, Ir—Fe, or Ir—Nd alloy, superparamagnetic Pt—Co, Pt—Fe, Pt—Nd, Ir—Co, Ir—Fe, or Ir—Nd nanoparticles, or non-magnetic Pt, Pt-alloy, Ir, IrOₓ, or Rh deposited on a magnetic nanoparticle such as Fe₃O₄, FeC, or the like. The catalyst may be a ferromagnetic Co-, Fe- or Ni-based material. The magnetic material may include Fe, Ni, Co, their alloys, magnetic alloys of rare-earth metals, naturally occurring magnetic minerals such as lodestone, iron oxide or ferrite, iron carbide or cementite or Fe₃C, neodymium magnet or NdFeB or Neo or NIB, aluminum nickel cobalt or AlNiCo, the like, or a combination thereof.

A non-limiting schematic example of the catalyst particle 100 is shown in FIG. 4A. The particle 100 includes the core 102 and the skin 104. While the particle is depicted as a round sphere, the surface may be undulating, irregular, faceted, or variable and include peaks and valleys, cavities, and/or protrusions outwardly emerging from the surface of the skin.

In at least one embodiment, the particle 100 may include the core 102 immediately adjacent to an intermediate layer 106, and the skin 104 immediately adjacent to the intermediate layer 106. The core 102 and the skin 104 are thus not in direct contact. In this embodiment, the core 102 includes one or more magnetic materials named herein. The core may be free of a precious metal.

The intermediate layer 106 includes a combination of a non-precious metal and precious metal such as Pt—Co, Pt—Ni, Pt—Fe, Ir—Co, Ir—Ni, Ir—Fe, Rh—Co, Rh—Ni, Rh—Fe, the like, their oxides, or a combination thereof. The non-precious metal may be magnetic. The non-precious metal may also include a different element than Co, Ni, or Fe, for example non-magnetic B, Al, Zn, Cu, Mn, Cr, Zr, Cd, Sn, Ce, the like, or their combination, for example to reduce the catalyst cost.

In at least one embodiment, the nanoparticles may be single phase nanoparticles. As such, the particles may be free of core-shell structure and rather include a combination, blend, or mixture of electromagnetic particles and precious metal particles or particles having a magnetic portion and precious metal portion.

The electrocatalyst may include a single type or a mixture of particles of the various types described herein. As such, the electrocatalyst may include magnetic particles having a core-shell structure, single phase, or a combination thereof.

In addition to the traditional components, the cell may include a magnet. The magnet may be an AC alternating magnet producing an AC magnetic field. The field may be a quickly alternating magnetic field or oscillating magnetic field. The AC current is a time-varying current, often sine-wave.

The magnet's oscillations may generate heat. The magnet presents a component with selective, local heating. The oscillating magnetic field may be used to heat up magnetic particles of the electrocatalyst. The heat generated by magnetic oscillations is not high enough or distributed enough spatially to cause agglomeration of the magnetic particles. Hence, the electrocatalyst may be free of particle agglomerations.

The oscillating field may have a frequency of up to about 1-500, 10-480, or 20-450 kHz. The oscillating field may have a frequency of about, at most about, or no more than about 1, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or 500 kHz. The oscillating magnetic field may have magnitude up to about 100 mT. The oscillating magnetic field may have magnitude of about, at most about, or up to about 1, 10, 20, 30, 40, 50, 60, 70, 80, 90, or 100 mT. The heating is accomplished using a combination of hysteretic dissipation or Neel dissipation, depending on whether the magnetic material has a non-zero magnetic coercivity.

Because the magnet affects only magnetic particles, its oscillations and heating do not negatively influence non-magnetic materials such as polymers in the electrochemical cell. The oscillating magnetic field generates heat which dissipates locally at the magnetic catalyst particles when subjected to the oscillating magnetic field. The localized heating of the catalyst enables improved atom interdiffusion leading to the formation of a closed precious metal shell and ordered intermetallic core to ensure high catalytic activity and stability of the catalyst. The principle of the magnetic heating concept disclosed herein is schematically shown in FIG. 5.

As can be seen in FIG. 5, the catalyst particle 100 is being subjected to the oscillating magnetic field generated by the AC magnet 120. The arrow in the catalyst circle denotes the fact that the catalyst 100 is magnetic, while the lines around the catalyst 100 illustrate the fact that only the catalyst 100 is being directly heated by the oscillating magnetic field. The catalyst is provided on a substrate 110 such as carbon, which is non-magnetic, and thus is not affected and heated by the oscillating magnetic field.

Inclusion of the magnet within the cell thus provides a way to synthesize a high performance catalyst, but also to regenerate an aging electrocatalyst, mend or increase robustness of the catalyst, and prevent leaching of the core through the skin during the catalyst's lifetime. The robust core also contributes to the stability of the skin and prevention of precious metal detachment from the nanocatalyst.

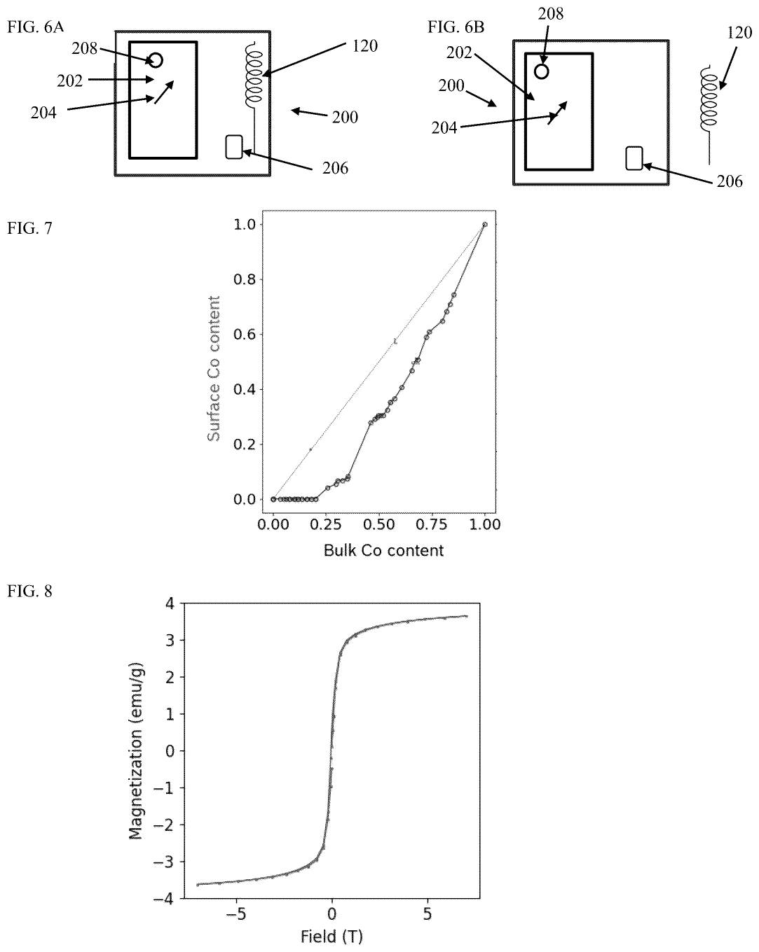

The AC magnet may be provided adjacent the catalyst powder during synthesis. Alternatively or in addition, the AC magnet may be provided as a permanent or temporary part of the cell. For example, the magnet may be provided adjacent the cell to regenerate the catalyst during a maintenance check, and the magnet may be removed from the vicinity of the cell at the end of the maintenance check. The magnet may be incorporated into the structure of the cell. The AC magnet may be an integral part of a cell. The AC magnet may be embedded in the cell partially or entirely. The magnet may be removable such that the magnet may be part of a cell temporarily. The magnet may be located in the vicinity or adjacent to the electrocatalyst material, layer(s), or coating(s) within the cell. A non-limiting example of a cell including the AC magnet according to one or more embodiments disclosed herein is shown in FIGS. 6A and 6B.

In FIG. 6A, the AC magnet 120 is an integral part of an electrochemical cell 200. The cell 200 includes a component 202 including magnetic catalyst material 204 marked with the arrow. A non-limiting example of the component 202 may be a cathode catalyst layer. In contrast, in FIG. 6B, the AC magnet 120 is not an integral part of the cell 200. The AC magnet 120 is temporarily provided adjacent the cell 200 to regenerate the catalyst 204.

A method of forming a magnetic electrocatalyst is disclosed herein. The method includes, comprises, consists of, or consists essentially of non-thermal annealing. The method may include generating localized heating of the catalyst using an oscillating magnetic field.

The method may include activating the oscillating magnetic field. The method may include generating localized heat via the oscillating magnetic. The method may include subjecting catalyst powder or a reactant mixture during the catalyst preparation to the oscillating magnetic field. The method may include primarily magnetically heating the magnetic particles or portions of the particles. The method may thus include selective, localized non-thermal annealing of the catalyst particles. The method may thus induce temperatures in the electrocatalyst particles that are higher than their surrounding by temperature differences of up to about 100K.

The method may include dissipating heat locally within the particles when subjected to the oscillating magnetic field. The method may include inter-diffusing atoms in the skin of the electrocatalyst to generate a closed precious metal shell. The method may include formation of an ordered intermetallic core.

The method is applicable to dry catalyst powder. The method may further include a wet chemical modification such as acid washing. The wet chemical modification may be conducted in a different or the same step as the annealing via oscillating magnetic field. The concept disclosed herein is applicable to synthesis, postprocessing, or regeneration of other magnetic particles. The concept is also applicable to formation of an ordered core from an initially disordered alloy. For example, the application of the magnetic heating may create an ordered Pt—Co core from an initially disordered alloy Pt—Co nanoparticle. The ordered structure may have improved catalytic activity and stability.

Additionally, the method may include using magnetic heating to induce a change in the shape of the catalyst nanoparticle, generating an increased fraction of high-activity facets such as crystalline Pt (111) or Pt (110), the like, or a combination thereof.

The magnetic heating may be either used as the only heat source during the annealing step, or in combination with a thermal heat source. For example, the catalyst synthesis method may include magnetic heating alone or in combination with thermal heating in vacuum, in a dry or humid gas such as nitrogen or air, in a reductive gas such as H₂.

The method may further include additional steps such as reductive alloying, acid washing, surfactant removal H₂ purging such as in Pt-salt solution. The method may be used as a single-step procedure.

The method may include oscillating magnetic field-induced annealing of a catalyst mixture, a solvent such as water, and one or more than one of the following chemical agents that support the formation of the desired core-shell structure with a stable precious metal shell: a reducing agent such as H₂, a precious metal salt such as hydrogen hexachloroplatinate (IV) hexahydrate (H₂PtCl₆·6H₂O), an acid such as sulfuric or nitric acid, or a combination thereof.

A method of regenerating an electrocatalyst including a ferromagnetic material after fabrication, use, or during a maintenance check is disclosed herein. The method may include providing an AC magnet generating an oscillating magnetic field in the vicinity of or adjacent to the electrocatalyst. The method may include activating the oscillating magnetic field to generate localized heat within the electrocatalyst. The method may include improving, mending, or maintaining robust core structure via application of the generated heat.

The method may include oscillating magnetic field-induced annealing of a full MEA containing the catalyst particles, carbon support, polymeric ionomer (e.g. Nafion), water, and a reductive atmosphere containing H₂. The annealing may be applied with the goal of recovering the pristine state of the catalyst and removing accumulated damage to the catalyst nanoparticle. The method may be used to recover the pristine state of the catalyst. In a non-limiting example, an oxidized Pt—Co particle with the chemical formula Pt—Co-Ox or some x>0 may be heated under reducing conditions to aid in the removal of oxygen damage, recovering the pristine state of the catalyst.

The application of the oscillating magnetic field and associated heating of the electrocatalyst may be conducted once, repeated, scheduled, random, predetermined, or their combination. The application of the oscillating magnetic field and associated heating may be activated manually or via a controller. The controller may receive input from one or more sensors structured to detect one or more properties of the electrocatalyst such as density, precious metal loading, temperature, the like, or a combination thereof. Based on the received input, the controller may activate the oscillating magnetic field to regenerate the electrocatalyst. A non-limiting schematic example of a controller and a sensor is shown in FIGS. 6A and 6B. The cell 200 in FIGS. 6A and 6B includes the AC magnet 120 and a component 202 having the magnetic catalyst material 204. The cell 200 further includes a controller 206 and the component 202 includes one or more sensors 208.

### EXAMPLES

### Example 1

FIG. 7 depicts the chemical composition of a PtCo catalyst nanoparticle in the bulk of the particle and its surface, at thermodynamic equilibrium. This data was obtained from an atomistic simulation of the preferred equilibrium structure of a PtCo alloy nanoparticle under representative conditions in a fuel cell environment. FIG. 7 shows that for a Co content below 25%, the surface thermodynamically prefers to form a pure Pt shell. Application of the oscillating magnetic field with the associated magnetic heating of the magnetic catalyst particles provides the catalyst particles the thermal energy needed to rearrange their structure towards the thermodynamically preferred state, which has a pure Pt shell around a mixed Pt—Co core.

### Example 2

FIG. 8 depicts the measured magnetization of a fuel cell electrode containing magnetic PtCo nanoparticle catalysts. The magnetization shows a typical superparamagnetic pattern with no hysteresis, indicating that magnetic heating can be achieved under a high-frequency magnetic field by the spin friction phenomenon.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An electrochemical cell comprising:
a membrane electrode assembly including an electrode catalyst material including a plurality of catalyst nanoparticles at least some of which include a magnetic material; and
an AC magnet generating oscillating magnetic field adjacent the catalyst material, the oscillating magnetic field having a frequency of up to 500 KHz.

2. The cell of claim 1, wherein the plurality of catalyst nanoparticles includes core-shell particles, each of which has a shell consisting of at least one precious metal and a core including the magnetic material.

3. The cell of claim 1, wherein the plurality of catalyst nanoparticles includes particles having a core including a mixture of at least one precious metal and a non-precious metal magnetic material.

4. The cell of claim 1, wherein the plurality of catalyst nanoparticles includes particles having a core including the magnetic material, a shell consisting of a precious metal material, and an intermediate layer between the core and the shell, the intermediate layer comprising a combination of a non-precious magnetic metal and a precious metal.

5. The cell of claim 1, wherein the magnetic material is a superparamagnetic material.

6. The cell of claim 1, wherein the oscillating magnetic field has a magnitude of up to about 100 mT.

7. The cell of claim 1, wherein the cell is a fuel cell.

8. The cell of claim 1, wherein the AC magnet is an integral part of the cell.

9. A system for catalyst regeneration in an electrochemical cell, the system comprising:
a membrane electrode assembly including an electrode catalyst material having a plurality of catalyst nanoparticles comprising a magnetic material;
a removable AC magnet generating oscillating magnetic field having a frequency of up to 500 kHz; and
a controller programmed to activate the oscillating magnetic field at a predetermined interval after the cell operation.

10. The system of claim 9, wherein the plurality of catalyst nanoparticles includes core-shell particles having a shell including a precious metal and a core including the magnetic material.

11. The system of claim 9 further comprising one or more sensors located on the electrode catalyst material, the sensors collecting input to be provided to the controller.

12. The system of claim 9, wherein the plurality of catalyst nanoparticles includes particles having a core including the magnetic material, a shell consisting of a precious metal material, and an intermediate layer between the core and the shell, the intermediate layer comprising a combination of a non-precious magnetic metal and a precious metal.

13. The system of claim 9, wherein the oscillating magnetic field has a magnitude of up to about 100 mT.

14. The system of claim 9, wherein the magnetic material includes Pt—Co, Pt—Ni, Pt—Fe, Ir—Co, Ir—Ni, Ir—Fe, Rh—Co, Rh—Ni, Rh—Fe, oxides of Pt—Co, Pt—Ni, Pt—Fe, Ir—Co, Ir—Ni, Ir—Fe, Rh—Co, Rh—Ni, Rh—Fe, or their combination.

15. A method of catalyst regeneration in an electrochemical cell, the method comprising:
providing an AC magnet adjacent a magnetic catalyst in the cell;
activating the AC magnet to generate an oscillating magnetic field;
selectively increasing temperature of the magnetic catalyst in the cell by the magnetic heat generated by the oscillating magnetic field while maintaining temperature of non-magnetic components of the cell; and
applying the magnetic heat for a period of time sufficient to increase crystallinity and structural stability of the catalyst.

16. The method of claim 15, wherein the activating is done periodically.

17. The method of claim 15, wherein the activating is based on input from one or more sensors collecting data from the catalyst.

18. The method of claim 15, wherein the activating is provided in reducing conditions to aid in removal of oxygen damage of the catalyst.

19. The method of claim 15, wherein the AC magnet is provided as an integral part of the cell.

20. The method of claim 15 further comprising applying the oscillating magnetic field at a frequency of up to 500 KHz.
